(19) United States
(12) Patent Application Publication
(10) Pub. No.: US 2012/0035282 A1
(43) Pub. Date: Feb. 9, 2012

(54) PROCESS FOR THE CONTINUOUS CYCLE RECYCLING OF MATERIALS CONTAINED IN PRODUCTS COUPLED TO OTHER MATERIALS BY DISINTEGRATION THROUGH WATER JETS AT HIGH/ULTRAHIGH PRESSURE AND PRODUCTS OBTAINED IN THIS WAY

(76) Inventors: Brunello Bernasconi, Cadro (CH); Vittorio Perregrini, Ascona (CH)

(21) Appl. No.: 13/057,462

(22) PCT Filed: Mar. 25, 2009
(86) PCT No.: PCT/EP09/02183

§ 371 Date: Feb. 3, 2011

(30) Foreign Application Priority Data
Apr. 24, 2008 (CH) 00673/08

(51) Int. Cl. C08J 11/06; B02C 23/18; C08F 36/00

(52) U.S. Cl. 521/45; 526/335; 241/39

(57) ABSTRACT

A process and a plant, even mobile, for the continuous cycle recycling of materials (2, 20) contained in products (1) coupled with other materials (V1 1″) by disintegration through water jets (5) at high flow ranging between 40-150 litre/minute and at high/ultra-high pressure ranging from 1700 to 6000 bar and products obtained from these.

As known used tires, as well as tracks, electrical cables and other products of mixed plastic/rubber/resin/metal put serious problems in their management as waste besides the recovery of not negligible commercial value of the re-useable materials that mean a resource of noticeable value.

The French Patent FR2882678 describes a process and a plant for the recycling of used tires but not well suitable for tires of large or extra-large dimensions, like those of the vehicles for building and road yards that must first be stripped or those ordinary that foresee pre-treatments of cutting of tires and their pre-arrangement or placing for the subsequent carrying-out of the phases of disintegration and recycling.

Furthermore the continuous variation of the surface of the product to be dismantled cannot be carried out in the above-mentioned French Patent without the use of pre-programmed computerized means, excluding any manual action, if an acceptable efficiency is desired.

This invention refers instead to a general process for the recycling of materials from used products, which does not foresee particular pre-treatments or preparation of said products.

Unlike the process of the above mentioned French Patent applicable only to tires of a certain type, which foresees preparatory phases and pre-treatments before the disintegration process of separation of the materials and needs a suitable arrangement of the surface of the product to be disintegrated under specific angles, the process of this invention, which can also be continuous, allow to attack, separate and clean the materials of the products of different type to be treated without any preliminary preparatory phase or arrangement. Furthermore unlike the above mentioned patent which foresees only the recycling of tires, this invention finds also use to the cleaning and recycling of shear material, see the cleaning of the music wire, coming from the mechanical grinders of tires.

That comes from the fact that the above mentioned French Patent relies for the disintegration and separation of the (mixed or not) tires, exclusively on the values of the jet(s) pressure, requiring at any time of the working process a well defined angle/direction of impact of the jet, hardly to control, to be effective.

That implies very long working times with very low productivity, strong limiting its use and employment.

The process subject of this invention, on the contrary, acting not only on the values of pressure of the water jet, but also basely on the values of its flow until 40-150 litre/minute and beyond, allows to obtain a quick disintegration of the product with the complete separation of the materials in case of mixed materials in economical times, increasing in such a way the specific power of the water jet [crashing shock mass at high pressure per time unit] and the capacity and the times of erosion and disintegration and/or separation and recycling.

Furthermore the large increase of the flow of the water jet(s) at high, ultra-high pressure allows obtaining a disposal of the heat generated during the process, limiting the temperature both of process water and recycling water, the low temperatures into play not invalidating the characteristics of the worked-out recycled materials that are disintegrated without modifying their properties.

A further advantage, against the process of the above mentioned French Patent Lambert, is that it is badly suitable for tires beyond a certain size, being the effect in this case practically negligible and that it is not applicable to the treatment of other types of products.

Furthermore the above-mentioned Patent does not foresee to carry out the process in a mobile system building a wheeled unity to be used directly “in loco”, especially in case of big products, and it is badly suitable for the treatment of big tires in the order of 4 metres and beyond.

On the contrary with the process subject of this invention it is possible to treat extremely well besides all the types of rubbers/tires, also tracks, conveyor belts, shearing materials from mills or grinders, cables, electrical cables, electrical and electronic products, removal and recycling of useful materials from surfaces and so on.

This invention refers in fact to a general process for the recycling of materials from used products coupled or not to other materials, like, besides tires of any size, cables, conveyor belts, tracks, electrical and electronic cards, mixed materials and so on, which does not foresee any particular, in our case any, operations of pre-treatment or preparation of said products.

To avoid the drawbacks of the Known Technique, the Applicant has now found out, and this is part of this invention, a process using water jets with high flow and under very high pressure.

In fact in this case, and this is part of this invention, the product is simply laid down on a surface however arranged or oriented (vertical, horizontal, inclined), the material or the outer layer of the mixed material being simply attacked by a big flow of water jets at high or ultrahigh pressure in relative motion (translation of the product and/or rotation of the heads) against the surface of the product to be disintegrated and recycled, irrespective the orientation of said surface to be disintegrated with respect to the direction of the jets and with full recycling of the employed water. Unlike the above mentioned Patent that foresees an operation of cutting and re-positioning of the product (tire) with respect to the nozzle of the disintegrator jet.

More precisely this invention refers to a:

Process of recycling of materials contained in products composed of single or coupled or mixed materials through a water jet at high or ultrahigh pressure coming from at least one nozzle or from at least one head carrying the supply nozzles, driven and set in relative motion against the disintegration surface of the product, previously treated or prepared, characterized by the fact that:
The disintegration of the products and the consequent separation and recycling of the materials occur without the necessity of any preliminary or preparatory phase of treatment of said product and irrespective of the orientation of the surface to be disintegrated with respect to the vector relevant to the jet of disintegration, relying only on the values of flow of the jets of water ejected by the heads carrying the nozzles of disintegration.

Such process is characterized in that,
The flow range is preferably comprised between 40-150 litre/min and beyond;
With a range of values of pressure comprised between 1700-6000 bar and beyond;
The range of the rotation speeds of the head(s) carrying the nozzles is comprised preferably between 500-3000 rev/min;
The range of the relative speeds of transportation of the product with respect to the head(s) varies preferably between 0-4 m/s,

And to be carried out as continuous cycle with disintegration, separation and packing of the materials composing the products and recycling and re-use of the water under pressure ejected by the jets of disintegration.

In a way of carrying out the process the material, preferably inert-metal mix, is conveyed and compacted by a vertical hopper to be decomposed by the action of the jets of a nozzle carrying head arranged inside the terminal outlet duct of the hopper itself.

In a different way in another variant of carrying out the process the head is arranged outside the hopper attacking the material on a conveyor belt for its decomposition and recycling.

In another way of carrying out the process of the invention the products to be disintegrated, preferably tires, are arranged on a conveyor belt and are conveyed and compressed by conveyor rollers of decreasing diameter like a wedge, to be channelled and forced to pass through a slot of a working station by whose exit they undergo the action of the flow of the water jets at high pressure and therefore attacked and disintegrated.

Such process can be carried out also vertically instead horizontally as before described, in such case the products are arranged vertically and directed on a conveyor belt provided with supporting and helping walls, conveyed and compressed by pincers rollers, channelled to pass through the passing slot at whose exit they undergo the action of the flow of the water jets at high pressure and therefore attacked and disintegrated.

In the process according to this invention the height of the passing opening of the slot is preferably comprised between 10 and 50 cm.

A further characteristic of the process according to this invention is the fact that the heads carrying the nozzles of the water jets at high, ultra-high pressure are driven by automated arms, controlled by computers.

It is part of this invention also:

Plant to carry out the process of this invention, characterized in that it includes means of transportation (conveyors), means of channelling and arranging the products, a fixed or mobile working surface or table, means for the supply of high flows of water at high pressure for the attack and disintegration of said products, means to direct, to collect, to separate and to manage the decomposed materials, means of collection and recycling of the water used in the process and drive and control means.

In a way of carrying out, the plant, according to this invention, to perform the process of the invention, includes a hopper where the mixed material, preferably metal-inert, is conveyed and compressed to be hit by the jets of a carrying nozzle head arranged inside the terminal outlet duct of the hopper itself, said decomposed mixed material being collected on a belt, recycled metal, and in a container, rubber or disintegrated inert, respectively.

In another way of carrying out the plant, to perform the process of the invention, it is characterized by that fact it includes a roller belt for the laying down and driving of the products, a unit containing the ejection nozzles of the water jets under pressure, a suction unit for the disintegrated materials produced in the working unit of the said water jets, a belt surface to drive and collect the metallic disintegrated material for its control and packing, a container to collect the inert disintegrated material, falling from the passing slots of said spaced rollers, in a unit of sorting and packing, with previous treatment of squeezing and consolidation of said inert and collection of the working water in a tank or vat, a recycling and filtering unit of said water.

The said disintegrating/cleaning plant metal/inert, to perform the process of the invention, can be duly adapted and made compact even to build a mobile station.

The plant, to perform the process according to this invention, in particular for the separation rubber metal from tires, is characterized by the fact that it includes a conveyor belt for their driving, horizontal, and treatment, conveyor rollers of decreasing diameter like a wedge, for their previous compression, channelling and forced passage through a slotted working station at whose exit they undergo the action of the flow of the water jets at high pressure, held by the nozzle carrying heads, and then attacked and disintegrated, a container to separate and collect the rubber, a surface or conveyor belt to collect and evacuate the metal.

The said plant to perform the process according to this invention, can be carried out vertically, characterized in this case in that it includes a conveyor belt to drive the products, in particular tires, provided with vertical walls to support them and help their feed for the vertical arrangement and transportation of said tires, vertical pincers rollers to compress and convey them, forcing their passage through the vertical slot of the working station at whose exit they undergo the action of the flow of the water jets at high pressure held the nozzle carrying heads, and then attacked, disintegrated and decomposed, and the obtained materials separated and collected.

The plant to carry out the process of the invention, applies also when the product to be disintegrated is a track or a conveyor belt.

Such plant, for the carrying out of the process of the invention can be also employed when the product to be disintegrated is a cable, in particular an electrical cable.

Similarly the plant of the invention finds particular application to electrical and/or electronic products.

The plant according to this invention can be carried out also as mobile station of disintegration, including a high pressure pump, a water tank, means to filter the water, a second vacuum aspirator pump, an inlet duct for the working water, a device to move, drive and control the arms which carries the plate holding the heads of the water jets of disintegration, to build an independent wheeled unit of transportation on a mobile frame.

In the plant subject of this invention, to carry out the process of the invention, the heads carrying the nozzles of the water jets disintegration are mobile horizontally and vertically, can rotate around their three axis, and auto-rotating by effect of the working water itself, being able to take up any required position.

Integral part of this invention are also the following ways of use of the materials obtained by disintegration of products, according to the process subject of this invention through the means or plants described for the carrying out of said process:

Use of the granule of disintegrated material obtained according to the process of the invention to produce products of recycled rubber, in particular to manufacture phono/thermo-insulating elements;
Use of the granule of disintegrated material obtained according to the process of the invention to produce elements of recycled rubber, in particular to manufacture floor elements, including anti-shock floors;
Use of the granule of disintegrated material obtained according to the above process, to produce charges for enamels and paints in general, for the use in any type of covering and/or protection of any fixed or mobile product;
Use of the granule of disintegrated material obtained according to the above process, to produce fuel and gas from granule/pounce.

In the same way integral part of this invention are also the following products, produced with the materials obtained by the means used to carry out the process subject of this invention:

Products of recycled rubber, in particular phono/thermo-insulating elements;
Elements of recycled disintegrated material, in particular elements for floors, including anti-shock floors;
Charges for enamels and paints in general, for use in any type of covering and/or protection of any fixed or mobile product;
Powder from recycled disintegrated material, in particular fuel and gas from granule/pounce.

We give here in the following a detailed description of some preferred ways to carry out the subject of this invention in relation to the process and the plant for its carrying out with reference to the drawings of the attached figures:

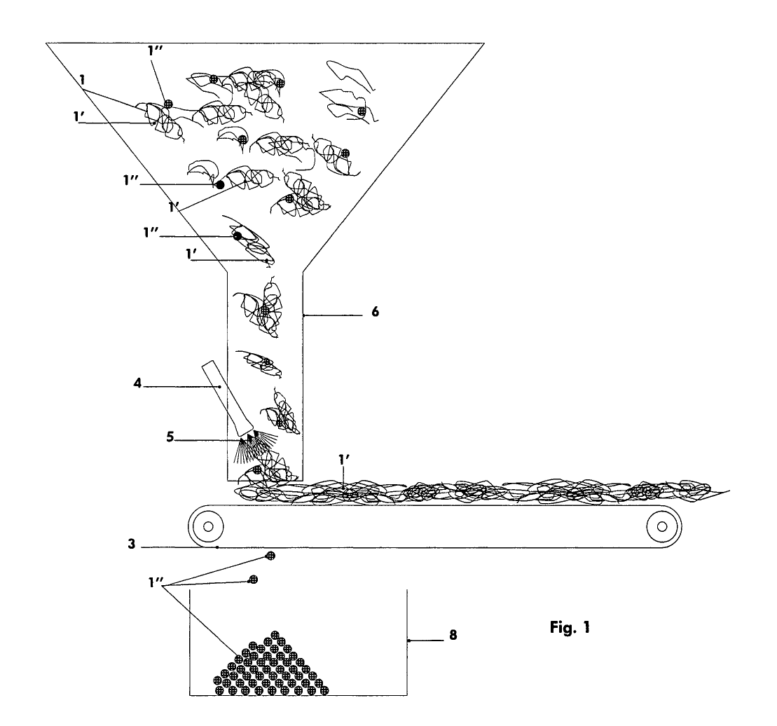

FIG. 1 shows a view of a plant to clean metal from rubber, to carry out the process in vertical according to the invention, applied to cleaning and recycling of mixed materials or shearing materials from disposal workings, with disintegrating water jets head arranged inside the loading hopper of the mixed material, generally inert-metal, said plant being particularly useful for cleaning of the music wire, coming from the mechanical grinders of tires;

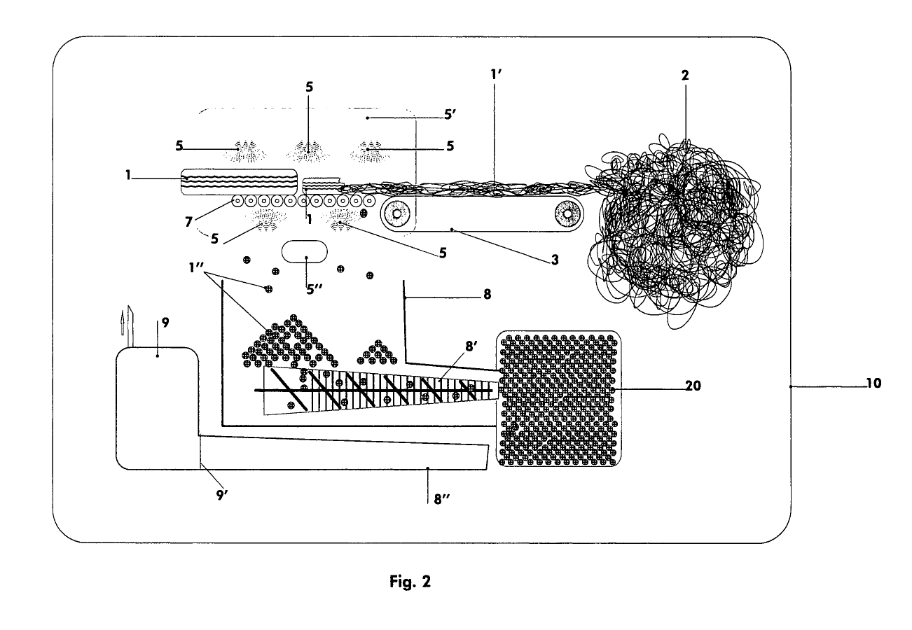

FIG. 2 shows a fixed plant, which can be transformed in a mobile station, of disintegration and/or separation of materials, in particular tires, through H₂O at high pressure in continuous cycle;

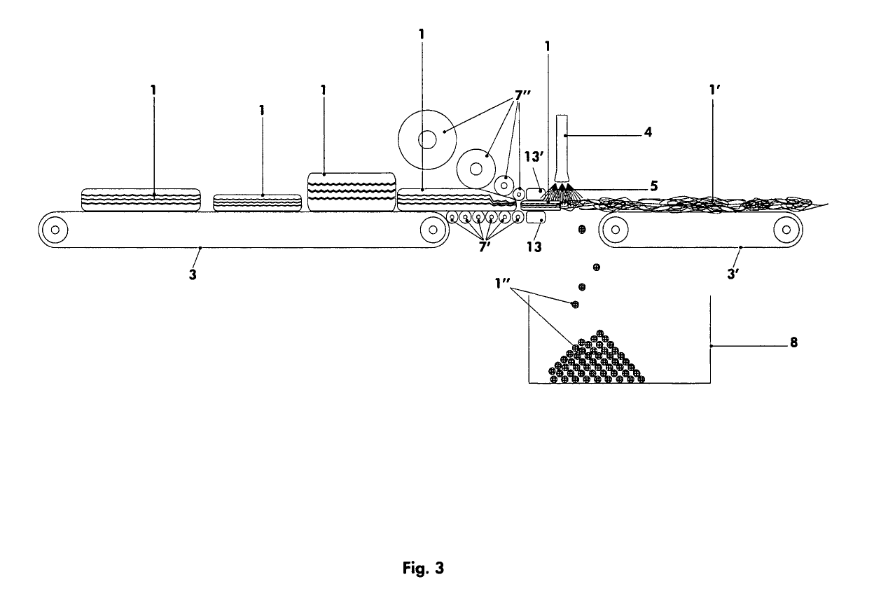

FIG. 3 shows a continuous cycle horizontal disintegrating/cleaning plant for tires to carry out the process to separation and recycling of the materials contained in them, provided with compressing conveyor rollers and with forced passage through a slot at the end;

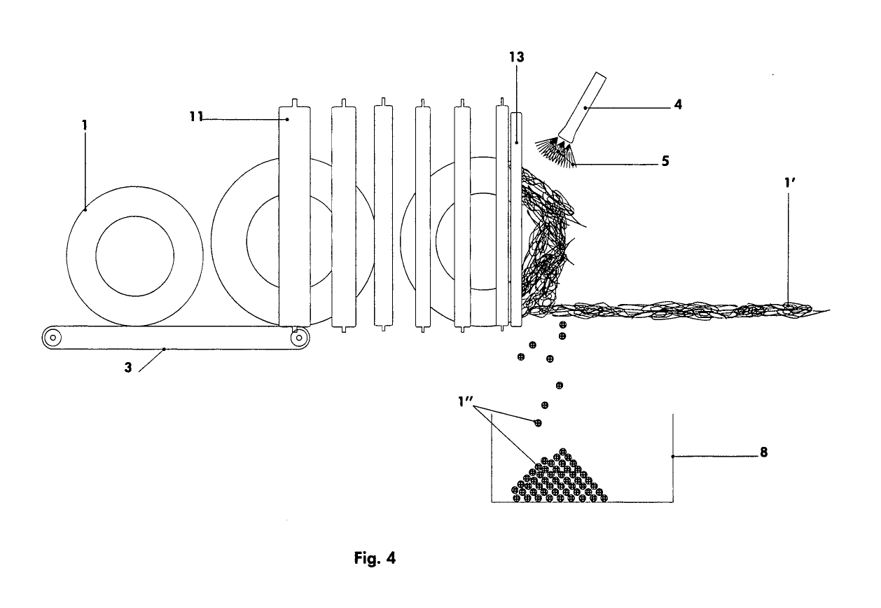

FIG. 4 shows a view of a vertical tire disintegration plant to carry out the process of the invention, provided with vertical conveyor compressing pincers rollers with a slot at the end, also vertically arranged;

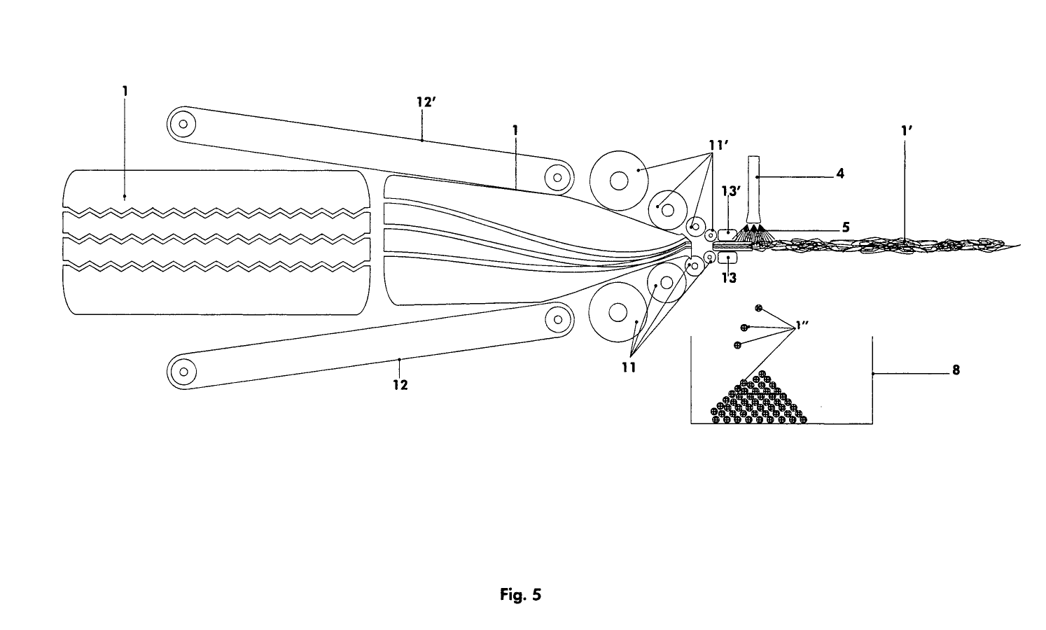

FIG. 5 shows a plan view of the plant shown in the above FIG. 4;

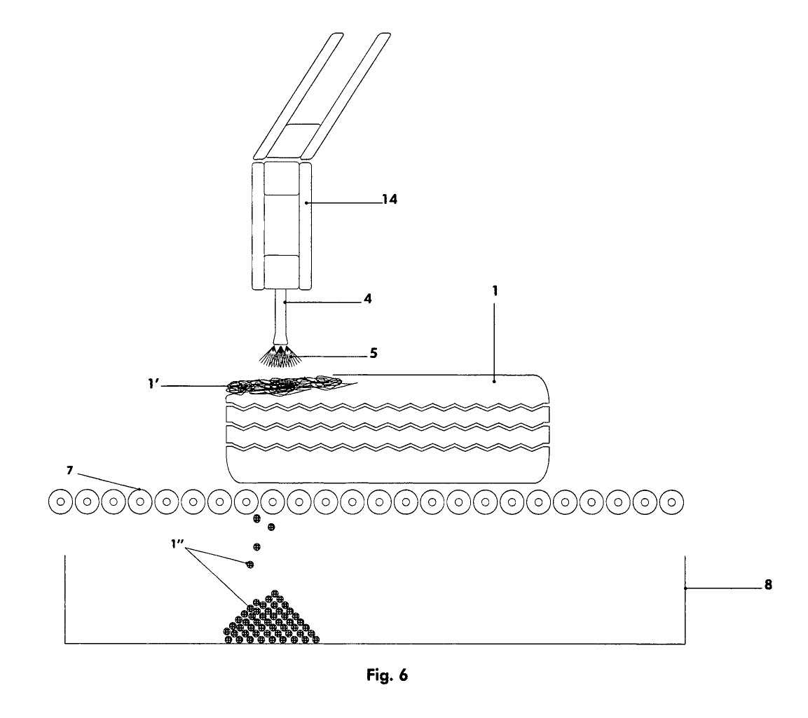

FIG. 6 shows a horizontal disintegrating plant for tires (of big size) with an automated arm carrying the heads of the water jets at high pressure;

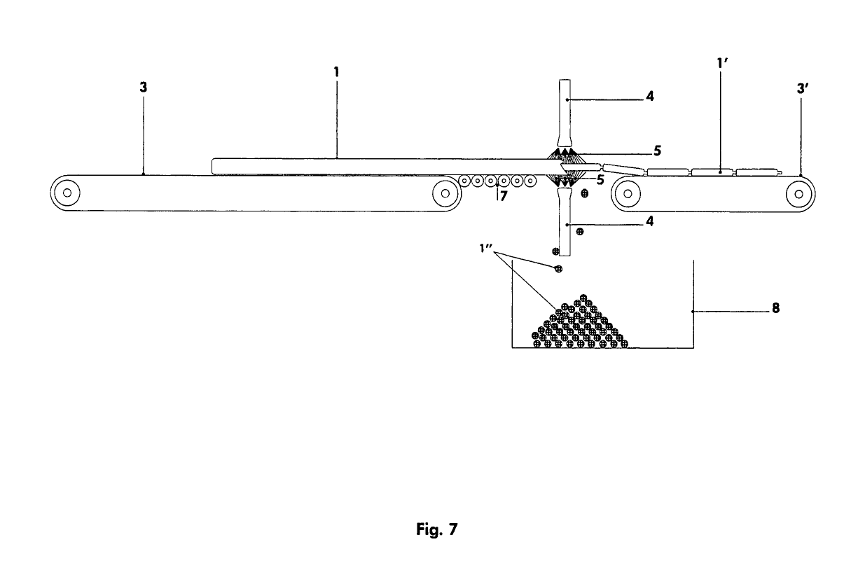

FIG. 7 shows a horizontal plant of disintegration of cover material of the tracks and full cleaning of their recyclable core, according to the process of the invention, provided with two opposed heads carrying the water jets at high pressure, respectively below and over the track to be decomposed;

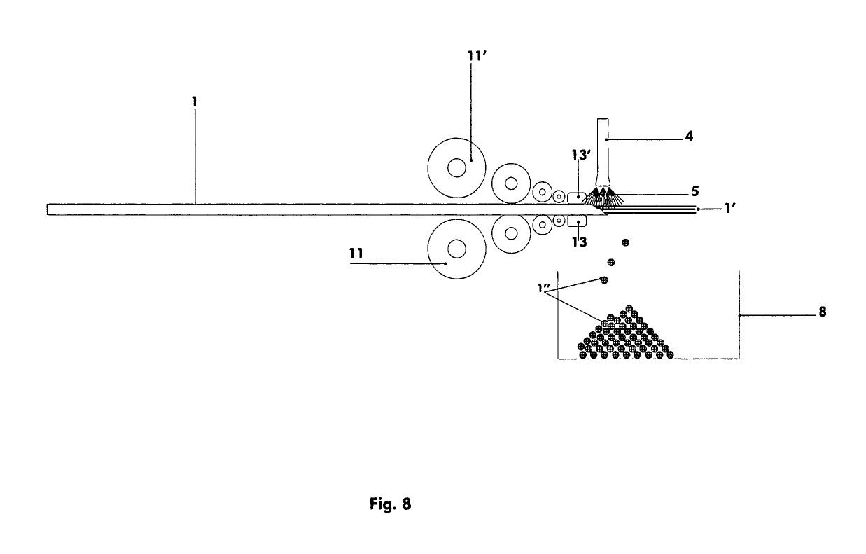

FIG. 8 shows a line of recycling, according to the process of this invention, of electrical cables by shattering of their cover material and cleaning of the internal metallic conductor, provided with “ad hoc” shaped grooved wedge conveyor rollers and a passing slot at the end;

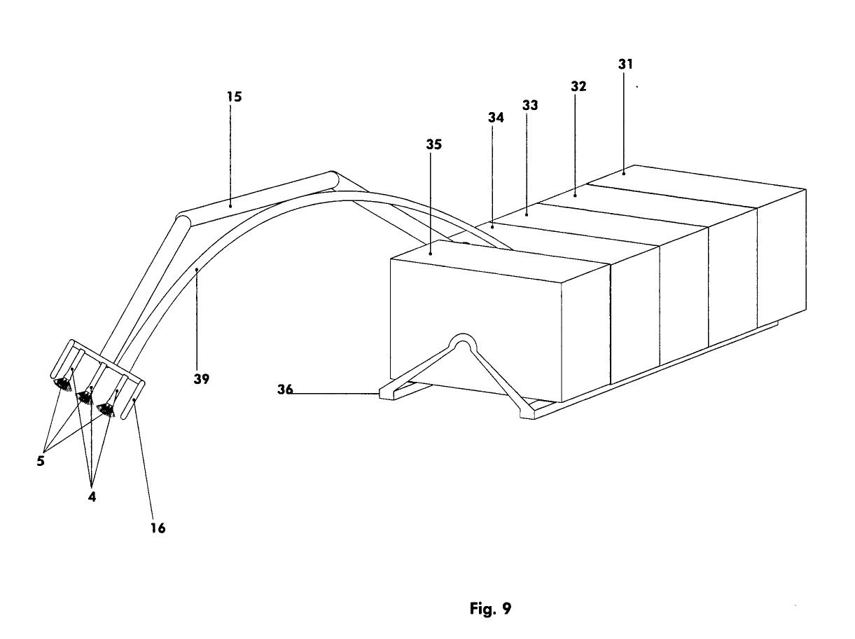

FIG. 9 shows the units composing a mobile disintegration station for the carrying out “in loco” of the process according to this invention;

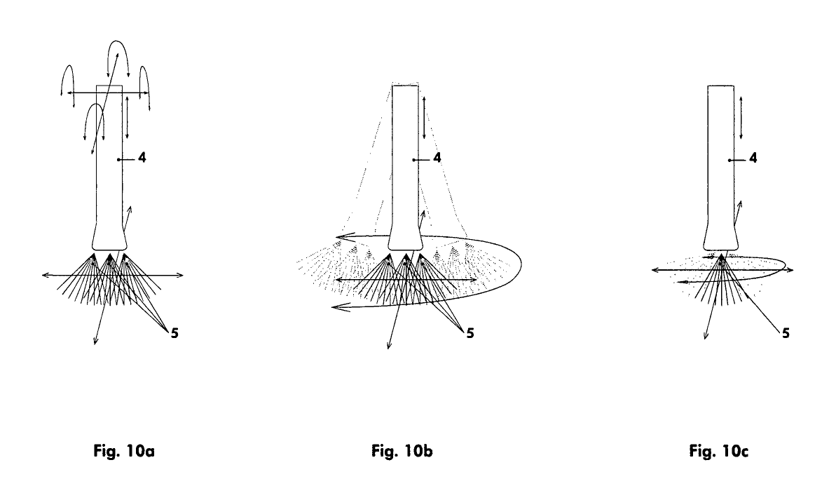

The FIGS. 10a, 10b and 10c show the movement of the disintegrating heads carrying the water jets at high pressure with variable flow, pressure and slant, according to the process of this invention, respectively in horizontal and vertical translation, swinging, rotation and auto-rotation by means of a kinetic torque triggered by the water under pressure itself.

Usually the traditional methods need a previous preparation and treatment of the products to be disintegrated, in case of tires they must undergo a cutting and the jets must hit under certain angles the surface of the product to be disintegrated to obtain some effect. Acting on the contrary on the values of the flow of jet it is possible to avoid all these drawbacks obtaining in an effective way the desired disintegrating effect with a good productivity, being not very important the relative position between hitting jet and hit surface, being not relevant the relative hitting direction of the disintegrating jet(s) against the surface to be disintegrated (vector relevant to the jet) to the effect of separation and recycling of the materials.

To facilitate and increase the effect of disintegration and separation and for a better management of the recycled material in addition in case of usual rubber, tires of small and medium size, they are compressed and let go through a slot station to undergo in a suitable way and the attack and disintegration action of the water jets. This thanks to a calculated and controlled specific power coming from the combination of high pressure and flow, being the value of water flow essential to the efficiency of the process. Furthermore that allows a better setting of the distance of the disintegrating jet from the product.

This process applies in particular to the recycling of the materials contained in scrap products of single or coupled or laid-down materials like:
Tires of any type and size, also beyond a diameter of 4 m;
Tracks;
Conveyor belts of rubber, plastic and derivates;
Cables: sheathed, covered, electrical conductors;
   Electrical and electronic components (disintegration of the supports of the insulators of rubber, resin o plastic and recycling of the noble materials);
Useful or noble materials in the cleaning or regeneration of ships, tankers, tanks, moulds or in general in the operations of removal or preparation of cover surfaces or surfaces of fixed or mobile products.

The products, usually tires, are convoyed by a hopper or a conveyor belt or shaped rollers for the cables, for small and medium size also a compression and channelling station is used to force them to pass through a slot at whose exit they are attacked and disintegrated.

Product to be disintegrated and disintegrating jet flowing out the ejection nozzles, mounted on rotating nozzle carrying heads, move one against the other, the first can stay and the second can move or the other way round or the two movements can combine, the important is the relative motion.

Usually the materials to be disintegrated, in particular rubber, maintain almost unchanged their chemical-physical characteristics that then allow a big spectre of re-use and application. That comes mainly from the limited warming undergone by the treatment water that does not deteriorate the disintegrated material keeping substantially its original properties. Furthermore it is to be considered the driving precision of the cutting when electronically assisted by automated working arms replacing the manual process.

In case of:

### Tires of Big Size Up to 4 M Diameter and Beyond or Tracks of Big Size

The tires of big size 1 for purpose of treatment as waste are arranged on a fixed or mobile table, rotating, 7, where they are knocked by the disintegrating water jets 5 flowing at high, ultra-high pressure out the nozzles of one or more nozzles carrying rotating heads 4 supported and driven by mechanical arms 14 manual controlled or automated according to computerized instructions. This usually for a fixed plant where the tire goes under the disintegration device. Otherwise a mobile installation on trailer or wheeled is foreseen, consisting of a transportable container or frame 36 that includes a tanker 31 for the treatment water, a filter and recycling unit 33 of said water, a motor pump at high pressure 31, a mechanical arm or bar 15, 16 carrying nozzles 5 that places itself on the product for its disintegration, a vacuum aspirator unit of the water 34, a container for the collection of the disintegrated material except the framing steel that remains separated on the place for its recycling, FIGS. 6 and 9.

In case of:

### Tires, Tracks of Medium, Small Size, Conveyor Belts, Cables

All the tires 1 are conveyed on a conveyor belt 3 in a dispenser however arranged (horizontal, slanted, vertical), for the cables a shaped roller conveyor 11, 11′, where they are slightly compressed after being driven and forced to pass through a slot 13, 13′ of an intermediate station, preferably of an height ranging from 10 and 50 cm. As the tire passes through said slot 13, 13′ it is attacked and disintegrated by the jets 5 at high pressure. In the same way for tracks or conveyor belts of small and medium size.

Likewise for the electrical cables 1 that are introduced in grooved rollers of different diameters 11, 11′ and then disintegrated in the same way. A unit 8 to collect and compact the disintegrated material or pounce closes the working cycle, FIGS. 3, 4, 5, 7 and 8.

### Use and Utilization

The granule of disintegrated material obtained according to the process subject of this invention is used preferably for the production of:
Products of recycled rubber, in particular to manufacture phono/thermo-insulating elements;
Granules/pounce-powder, in particular to produce fuel and gas, to obtain energy;
Elements for all the types of floors, including anti-shock floors;
Charges for enamels and paints in general for all the types of cover and/or protection of any fixed or mobile product.

### Obtained Products

Products of recycled rubber, in particular to manufacture phono/thermo-insulating elements;
Granules/pounce, in particular to produce fuel and gas, to obtain energy;
Elements for all the types of floors, including anti-shock floors;
Charges for enamels and paints in general for all the types of cover and/or protection of any fixed or mobile product.

### EXAMPLE 1

### Cleaning and Recycling of Sheared Material by Internal or External Disintegrating Head

The material 1, preferably mixed inert 1″, metal 1′, is convoyed and compacted by a vertical hopper 6 to be decomposed by the crash action of the jets 5 of a nozzle carrying head 4 arranged inside the terminal outlet duct of the same hopper 6, the metal 1′ is evacuated by the belt 3, the disintegrated material 1″ collected in the container 8, FIG. 1.

Said head 4 in a different variant is arranged outside the terminal part of said hopper 6 attacking the material 1 on the conveyor belt 3 for its decomposition and recycling, 1′, 1″.

### EXAMPLE 2

### Mobile or Fixed Station of Disintegration and/or Separation of Materials in Continuous Cycle by Means of Water Jet at High Pressure

The fixed or mobile station 10 of disintegration and recycling includes a roller belt 7 for the lay down and drive of the material 1, a phonoinsulated unit or box of disintegration 5′ containing the ejection nozzles of the jets 5 of the water under pressure, an aspirator unit 5″ of the disintegrated materials 1″ produced in said working unit of the water jets or disintegration box 5′, a belt surface 3 of driving and collection of the metallic disintegrated material 1′ for its control and packing 2, a container 8 for the collection of the inert disintegrated material 1″ coming from the passing slots of said spaced rollers 7 in a sorting and packing unit 20, after treatment of squeezing and compacting of said inert 1″ in a compartment 8′ and collection of the working water in the collecting tank or vat 8″, a unit 9 of recycling and filtering of said water. The compartment 8′ can comprise a separation filter for the water as well as a worm screw to squeeze and compact the material 1″, FIG. 2.

### EXAMPLE 3

### Continuous Cycle Disintegration of Tires in Horizontal

The products 1 to be disintegrated, preferably tires, in particular for the separation rubber-metal from tires, laid down on a conveyor belt 3 for their horizontal driving, are conveyed and compressed by wedge-shaped conveyor rollers 7′, 7″ of decreasing diameter, to be channelled, squeezed and forced to pass through a slotted working station 13, 13′ where their undergo a compression, at whose exit they undergo the action of the flow of the water jets 5 at high pressure held by the nozzle carrying head 4 and then attacked and disintegrated. The height of the passing slot ranges preferably between 10 and 50 cm. A container 8, of separation and collection of the rubber 1″, and a surface or conveyor belt 3′, of collection and evacuation of the metal 1′, complete the cycle of treatment of the products, FIG. 3.

### EXAMPLE 4

### Continuous Cycle Disintegration of Tires in Vertical

The products 1 are arranged vertically and driven on a conveyor belt 3 provided with vertical supporting and helping walls 12, 12′ for the vertical arrangement and transportation of said tires, then conveyed and compressed by vertical pincers rollers 11, 11′, and channelled to pass through the passing slot 13, 13′ where they are crushed, undergoing at the exit the action of the flow of the water jets 5 at high pressure held by the nozzle carrying head 4 and then attacked and disintegrated. The height of the passing slot ranges preferably between 10 and 50 cm. The materials obtained in this way 1′ (metal), 1″ (rubber). are separated and collected, on conveyors 3′ and containers 8 respectively, FIGS. 4 and 5.

### EXAMPLE 5

### Disintegration of Tracks

The process and the plant described in the previous example apply to the disintegration of tracks or conveyor belts as well, FIG. 7.

### EXAMPLE 6

### Disintegration of Electrical Cables

The process and the plant described in the examples 4 and 5 above apply to the disintegration of cables as well, in particular electrical cables, FIG. 8.

### EXAMPLE 7

### Wheeled Mobile Station of Disintegration

The mobile station mobile of disintegration includes a pump 31 generating high pressure, a water tank 32, filtering means 33 of the water, a second aspirator vacuum pump 34, an inlet duct 39 of the working water, a control device or mean 35 to move, drive and control the arm 15 carrying the plate 16 holding the heads 4 of the water jets 5 of disintegration, to build an independent unit of transportation wheeled on a mobile frame 36, FIG. 9.

### EXAMPLE 8

### Disintegrating Heads

The heads 4 carrying the nozzles of the water jets 5 of disintegration are moveable in horizontal and vertical translation, can rotate around their three axis, and auto-rotate, by effect of the working water itself, being able to take up any required position, on jet oriented in any direction, FIGS. 10a, 10b, 10c.

1. Process of recycling of materials contained in products composed of single, coupled or mixed materials through a jet of water at high or ultra high pressure coming from at least one nozzle or from at least one supply nozzle carrying head, the head carrying the supply nozzles, driven and set in relative motion against the disintegration surface of the product, previously treated or prepared, wherein,
the disintegration of the product and the consequent separation and recycling of the materials occurs without the need of any preliminary or preparatory phase of treatment of said product, and irrespective of the orientation of the surface to be disintegrated with respect to the vector relevant to the jet of disintegration, relying only on the values of flow of the jets of water ejected by the heads carrying the nozzles of disintegration.

2. The process according to the claim 1, wherein the,
flow range is preferably comprised of between 40-150 litre/minute and beyond, and having
a range of values of pressure comprised of between 1700-6000 bar and beyond, the
range of the rotation speeds of the head(s) carrying the nozzles being comprised of preferably between 500-3000 rev/min; the
range of the relative speeds of transportation of the product with respect to the head(s) varies preferably between 0-4 m/s.

3. The process according the claim 1, wherein the process is carried out as a continuous cycle with disintegration, separation and packing of the materials composing the products and recycling and re-use of the water under pressure ejected by the jets of disintegration,

4. The process according to claim 1, wherein the material is a mixed inert metal conveyed and compacted by a vertical hopper to be decomposed by the action of the jets of a nozzle carrying head arranged inside the terminal outlet duct of the hopper

5. The process according to the claim 4, wherein said head is arranged outside the hopper attacking the material on the conveyor belt for its decomposition and recycling

6. The process according to claim 1, wherein the products to be disintegrated, preferably tires, are arranged on a conveyor belt and are conveyed and compressed by conveyor rollers of decreasing diameter like a wedge, to be channelled and forced to pass through a slot of a working station by whose exit they undergo the action of the flow of the water jets at high pressure and therefore attacked and disintegrated,

7. The process according to claim 6, wherein said products are arranged vertically and directed on a conveyor belt provided with supporting and helping walls conveyed and compressed by pincers rollers channelled to pass through the passing slot at whose exit they undergo the action of the flow of the water jets at high pressure and therefore are attacked and disintegrated,

8. The process according to claim 6, wherein the height of the passing opening of the slot ranges preferably between 10 and 50 cm.

9. The process according to claim 1, wherein the nozzle carrying heads of the water jets at high, ultra-high pressure are driven by automated means controlled by computerized means

10. A plant to carry out the process according to claim 1, wherein the plant includes means of transportation (conveyors), means of channelling and arranging the products, a fixed or mobile working surface or table, means for the supply of high flows of water at high pressure for the attack and disintegration of said products, means to direct, collect, separate and manage the decomposed materials, means of collection and recycling of the water used in the process and drive and control means.

11. The plant according to claim 10, to carry out the process according to claim 1, wherein the plant includes a hopper where the mixed material preferably metal-inert, is conveyed and compressed to be hit by the jets of a carrying nozzle head arranged inside the terminal outlet duct of said hopper said decomposed mixed material being collected on a belt metal and in a container rubber or inert, respectively.

12. The plant according to claim 10, to carry out the process according to claim 1, wherein the plant includes a roller belt for the laying down and driving of the products a unit containing the ejection nozzles of the jets of water under pressure, an aspirator unit of the disintegrated materials produced in said working unit of the water jets a belt surface of driving and collection of the metallic disintegrated material for its control and packing a container for the collection of the inert disintegrated material from the passing slots of said spaced rollers in a sorting and packing unit after treatment of squeezing and compacting of said inert and collection of the working water in the collecting tank or vat a unit of recycling and filtering of said water,

13. A disintegration/cleaning plant according to claim 12, to carry out the process according to the claim 1, wherein a mobile station is built

14. The plant according to claim 10, to carry out the process according to claim 1, in particular for the separation rubber metal from tires wherein the plant includes a conveyor belt for the driving, horizontal, and treatment, conveyor rollers of decreasing diameter like a wedge, for their previous compression, channelling and forced passage through a slotted working station at whose exit they undergo the action of the flow of the water jets at high pressure, held by the nozzle carrying head and then attacked and disintegrated, a container to separate and collect the rubber a surface or conveyor belt to collect and evacuate the metal

15. The plant according to claim 14, to carry out the process according to claim 1 wherein the plant includes a driving conveyor belt provided with vertical supporting and helping walls for the arrangement and vertical transportation of said tires, vertical pincer rollers for their compression and channelling through the vertically slotted station of forced passage at whose exit they undergo the action of the flow of the water jets at high pressure, held by the nozzle carrying head and then attacked and disintegrated the materials obtained in this way separated and collected,

16. The plant according to claim 10, to carry out the process according to claim 1, wherein the product to be disintegrated is a track or a conveyor belt,

17. The plant according to claim 10, to carry out the process according to claim 1, wherein the product to be disintegrated is a cable, in particular an electrical cable,

18. The plant according to claim 10, to carry out the process according to claim 1, wherein the plant further comprises of a mobile station of disintegration including a pump generating high pressure, a water tank filtering means of the water, a second aspirator vacuum pump an inlet duct of the working water, a control device or mean to move, drive and control the arm carrying the plate holding the heads of the water jets of disintegration, to build an independent unit of transportation wheeled on a mobile frame,

19. The plant according to claim 10 to carry out the process according to claim 1, wherein the heads carrying the nozzles of the water jets of disintegration are moveable in horizontal and vertical translation, can rotate around their three axis, and auto-rotate, by effect of the working water itself, being able to take up any required position,

20. Use of the granule of disintegrated material obtained according to the process of claim 1, to produce products of recycled rubber, in particular to manufacture phono/thermo-insulating elements.

21. Use of the granule of disintegrated material obtained according to the process of claim 1, to produce elements of recycled rubber, in particular to manufacture floor elements, including anti-shock floors.

22. Use of the granule of disintegrated material obtained according to the process of claim 1, to produce charges for enamels and paints in general, for the use in any type of covering and/or protection of any fixed or mobile product.

23. Use of the granule of disintegrated material obtained according to the process of claim 1, to produce fuel and gas from granule/powder.

24. Products of recycled rubber according to claim 20, in particular phono/thermo-insulating elements.

25. Elements of recycled disintegrated material according to claim 21, in particular floor elements, including anti-shock floors.

26. Charges for enamels and paints in general according to claim 22, for the use in any type of covering and/or protection of any fixed or mobile product.

27. Powder from recycled disintegrated material according to claim 23, in particular fuel and gas from granule/powder.
